(19) United States
(12) Patent Application Publication
(10) Pub. No.: US 2019/0242981 A1
(43) Pub. Date: Aug. 8, 2019

(54) TARGET DETECTING DEVICE

(71) Applicants: Naoki Otani, Aichi (JP); Hoshibumi Ichiyanagi, Aichi (JP)

(72) Inventors: Naoki Otani, Aichi (JP); Hoshibumi Ichiyanagi, Aichi (JP)

(73) Assignee: OMRON AUTOMOTIVE ELECTRONICS CO., LTD., Aichi (JP)

(21) Appl. No.: 16/269,068

(22) Filed: Feb. 6, 2019

(30) Foreign Application Priority Data
Feb. 7, 2018 (JP) 2018-019755

(51) Int. Cl. G01S 7/481; G01B 11/26; G02B 26/08; G01S 17/42; G01S 17/08; G01J 1/04

(52) U.S. Cl. CPC G01S 7/4817; G01B 11/26; G01J 1/0407; G01S 17/42; G01S 17/08; G02B 26/0816

(57) ABSTRACT

A target detecting device includes: an optical scanner including a mirror; and a casing. The target detecting device further includes a light shielding portion configured to partition the casing into a light projecting space through which projected light travels and a light receiving space through which reflected light travels and configured to block light. The mirror has a first reflecting region which reflects the projected light and a second reflecting region which reflects the reflected light, the first reflecting region and the second reflecting region being located in an identical reflecting surface. The light shielding portion includes: a movable light shielding portion provided on the mirror so as to separate the first reflecting region and the second reflecting region and configured to be movable in conjunction with the mirror; and a fixed light shielding portion fixed to the casing so as to surround the movable light shielding portion.

### CROSS-REFERENCE TO RELATED APPLICATION

This application is based on Japanese Patent Application No. 2018-019755 filed with the Japan Patent Office on Feb. 7, 2018, the entire contents of which are incorporated herein by reference.

### FIELD

The present invention relates to a target detecting device which projects light from a light emitting element, receives the reflected light with a light receiving element, and detects a target according to a light reception signal output from the light receiving element.

### BACKGROUND

For example, a target detecting device such as a laser radar is mounted on a vehicle having a collision prevention function. This target detecting device detects a preceding vehicle, a person, a road, another object or the like existing in the traveling direction of the vehicle as a target and detects the distance to the target.

There are a radio target detecting device and an optical target detecting device. Among them, the optical target detecting device includes a light emitting element that projects light, a light receiving element that receives light and outputs a light reception signal corresponding to the light receiving state, and the like. As the light emitting element, a laser diode or the like is used. As the light receiving element, a photodiode, an avalanche photodiode or the like is used. In addition, in order to project and receive light over a wide range, a plurality of light emitting elements and light receiving elements may be used.

There is also a target detecting device including an optical scanner that performs scanning with light in the horizontal direction or the vertical direction in order to project and receive light over a wide range or to reduce the size of the target detecting device (for example, JP 2014-52366 A, JP 2014-219250 A, and JP 2002-31685 A).

The target detecting device disclosed in JP 2014-52366 A includes an optical scanner having a hexahedron-shaped mirror. The four sides of the mirror are reflecting surfaces and are inclined at different angles with respect to the rotation axis. By rotating the mirror about the rotation axis, projected light projected from the light emitting element (laser light source) is reflected by each reflecting surface of the mirror and a predetermined range is scanned. Reflected light reflected by a target in the predetermined range is reflected by each reflecting surface of the mirror and is guided to a light receiving element (photodetector). During this light projection and reception, scanning is performed with the projected light and the reflected light not only in the horizontal direction but also in the vertical direction.

The target detecting device disclosed in JP 2014-219250 A includes a first scanning mirror and a second scanning mirror. Each of these scanning mirrors is formed in a plate shape, and a plate surface of each scanning mirror serves as a reflecting surface. By using a controller to change the angle of the first scanning mirror, light projected from a light emitting element is reflected by the first scanning mirror, and the predetermined range is scanned with the light. In addition, by using the controller to change the angle of the second scanning mirror, reflected light reflected by a target in the predetermined range is reflected by the second scanning mirror and is guided to a light receiving element.

The target detecting device disclosed in JP 2002-31685 A includes an optical scanner having a polygon mirror. Six reflecting surfaces of the polygon mirror are inclined with respect to the rotation axis of the polygon mirror. By rotating the polygon mirror about the rotation axis, projected light projected from a light emitting element is reflected by each reflecting surface of the polygon mirror and a predetermined range is scanned. In a casing that houses each unit of the target detecting device, a partition wall separates a light projecting space in which the light emitting element, the polygon mirror and the like are provided, and a light receiving space in which the light receiving element and the like are provided. Reflected light reflected by a target in the predetermined range enters the light receiving space not via the polygon mirror and is received by the light receiving element.

In contrast, JP 2004-125554 A and JP 06-74763 disclose techniques of preventing stray light generated in a device from being received by a light receiving element in order to suppress deterioration in detection accuracy.

JP 2004-125554 A discloses that, in a mirror angle detecting device that detects the angle of a movable mirror, a projected light from a light emitting element passes through a beam splitter and a condenser lens, and then is emitted to the movable mirror. The reflected light reflected by the movable mirror passes through the condenser lens and the beam splitter and then is received by the light receiving element. A light shielding plate for preventing stray light from the light receiving element or a peripheral member from reaching the light receiving element is provided between the beam splitter and the condenser lens. An opening passing light therethrough is formed in a central portion of the light shielding plate. As a result, a main beam and the reflected main beam from the movable mirror pass through the opening of the light shielding plate and are received by the light receiving element. Therefore, stray light is blocked by the light shielding plate and does not enter the light receiving element.

JP 06-74763 discloses that a distance measuring device that measures the distance to a target includes a light receiving lens barrel that captures reflected light from a target, in addition to an illuminating lens barrel that emits laser light. A light receiving lens is provided at a front opening of the light receiving lens barrel, a light receiving element is provided at a deep inside, and a light shielding plate is provided between the light receiving lens and the light receiving element. The light shielding plate is obtained by shaping a thin plate whose surface is subjected to antireflection treatment such that the thin plate protrudes into a conical shape and removing a small-diameter portion of the conical shape to form an opening. By using the two light shielding plates in combination, even if sunlight having entered through a peripheral edge portion of the light receiving lens is reflected by an inner wall of the light receiving lens barrel or the light shielding plate to become stray light, the stray light is blocked by the light shielding plate and does not enter the light receiving element.

For example, in the case of using an optical scanner in which an identical reflecting surface of a mirror reflects projected light from a light emitting element and reflected light from a target as in JP 2014-52366 A, the size of a target detecting device can be further reduced compared with a case of using an optical scanner in which different reflecting surfaces reflect projected light and reflected light or a case of using an optical scanner that uses a mirror to scan only one of projected light and reflected light. However, unless a light projecting space through which projected light travels and a light receiving space through which reflected light travels are not separated in the device, the likelihood that part of the projected light and the reflected light will become stray light and randomly enter the light receiving space and the light projecting space and the light receiving element will receive the stray light increases. In addition, when the light receiving element receives the stray light, noise included in the light reception signal output from the light receiving element becomes great, and detection accuracy of a target based on the light reception signal may deteriorate. In particular, in a case of using a light receiving element with high light reception sensitivity, the light receiving element is more likely to receive stray light, noise based on the stray light included in the light reception signal becomes greater, and a target may not be accurately detected according to the light reception signal.

### SUMMARY

An object of the present invention is to provide a target detecting device capable of effectively suppressing entry of stray light from a light projecting space to a light receiving space.

A target detecting device according to the present invention includes: a light emitting element configured to project light; a light receiving element configured to receive light and to output a light reception signal; an optical scanner including a mirror and configured to change orientation of the mirror to cause the mirror to reflect projected light projected from the light emitting element to scan a predetermined range and to cause the mirror to reflect reflected light from a target in the predetermined range of the projected light to guide the reflected light to the light receiving element; a detector configured to detect the target according to the light reception signal that the light receiving element outputs according to a light reception state of the reflected light; a casing configured to store the light emitting element, the light receiving element, the optical scanner and the detector; and a light shielding portion configured to partition the casing into a light projecting space through which the projected light travels and a light receiving space through which the reflected light travels and configured to block light. The mirror has a first reflecting region which reflects the projected light and a second reflecting region which reflects the reflected light. The first reflecting region and the second reflecting region are located in an identical reflecting surface. The light shielding portion includes a movable light shielding portion provided on the mirror so as to separate the first reflecting region and the second reflecting region and configured to be movable in conjunction with the mirror, and a fixed light shielding portion fixed to the casing so as to surround the movable light shielding portion.

According to the above, in the light projecting space and the light receiving space in the casing of the target detecting device, part of the light projecting space and part of the light receiving space near the mirror of the optical scanner are separated by the movable light shielding portion provided on the mirror, and part of the light projecting space and part of the light receiving space surrounding the movable light shielding portion are separated by the fixed light shielding portion fixed to the casing. Therefore, for example, the movable light shielding portion and the fixed light shielding portion prevent part of the projected light from the light emitting element from becoming stray light and entering the light receiving space from the light projecting space, and prevent part of the reflected light from a target becoming stray light and entering the light projecting space from the light receiving space. Therefore, it is possible to effectively reduce the likelihood that the light receiving element will receive the stray light.

In the present invention, a gap between the movable light shielding portion and the fixed light shielding portion may be narrowed to such an extent that the fixed light shielding portion does not inhibit movement of the mirror and the movable light shielding portion.

In addition, in the present invention, a step may be provided on at least one of an outer peripheral portion of the movable light shielding portion and an inner peripheral portion of the fixed light shielding portion facing the outer peripheral portion.

In addition, in the present invention, a step may be provided on the outer peripheral portion of the movable light shielding portion, and this step may be formed between an end surface of the outer peripheral portion closer to the first reflecting region and an end surface of the outer peripheral portion closer to the second reflecting region. One of the end surfaces may be closer to the inner peripheral portion of the fixed light shielding portion than the other is.

In addition, in the present invention, a step may be provided on the inner peripheral portion of the fixed light shielding portion, and this step may be formed between an end surface of the inner peripheral portion closer to the first reflection region and an end surface of the inner peripheral portion closer to the second reflecting region. One of the end surfaces may be closer to the outer peripheral portion of the movable light shielding portion than the other is.

In addition, in the present invention, a step may be provided on the outer peripheral portion of the movable light shielding portion, a step may also be provided on the inner peripheral portion of the fixed light shielding portion, and the step on the outer peripheral portion and the step on the inner peripheral portion may form a bent gap between the movable light shielding portion and the fixed light shielding portion.

Further, in the present invention, one of the outer peripheral portion of the movable light shielding portion and the inner peripheral portion of the fixed light shielding portion may be formed in a projecting shape so as to protrude toward the other and may have a plurality of steps, and the other may be formed in a recessed shape so as to be recessed toward the side opposite to the one and may have a plurality of steps.

According to the present invention, it is possible to provide a target detecting device capable of effectively suppressing entry of stray light from the light projecting space to the light receiving space.

### BRIEF DESCRIPTION OF THE DRAWINGS

FIG. 1A is a rear view of an optical system of a target detecting device according to an embodiment of the present invention.

FIG. 1B is a view illustrating a case where the orientation of a mirror is changed in FIG. 1A.

FIG. 2A is a top view of the optical system of FIG. 1A.

FIG. 2B is a top view of the optical system of FIG. 1B.

FIG. 2C is a top view of the lower side with respect to a light shielding portion of FIG. 1B.

FIG. 3 is a diagram illustrating an electrical configuration of the target detecting device.

FIGS. 4A and 4B are enlarged sectional views of a main part of a first embodiment.

FIGS. 5A and 5B are enlarged sectional views of a main part of a second embodiment.

FIGS. 6A and 6B are enlarged sectional views of a main part of a third embodiment.

FIG. 7 is an enlarged sectional view of a main part of a fourth embodiment.

FIG. 8 is an enlarged sectional view of a main part of a fifth embodiment.

FIG. 9 is an enlarged sectional view of a main part of a sixth embodiment.

### DETAILED DESCRIPTION

Hereinafter, embodiments of the present invention will be described with reference to the drawings. In the drawings, identical or corresponding parts are denoted by identical reference signs.

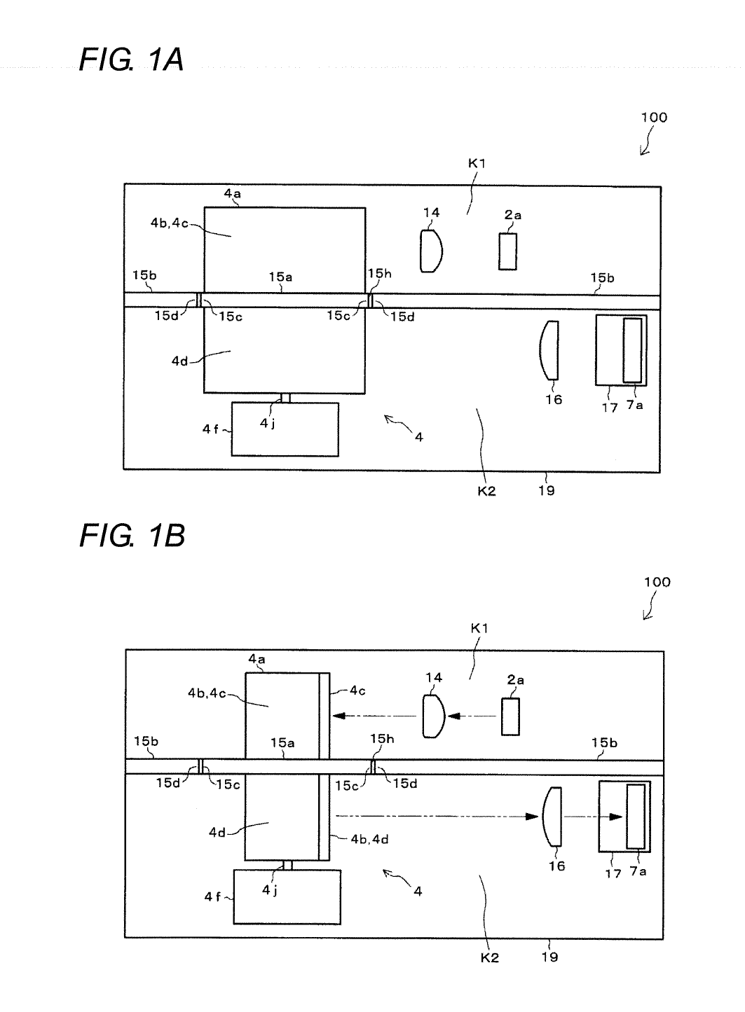

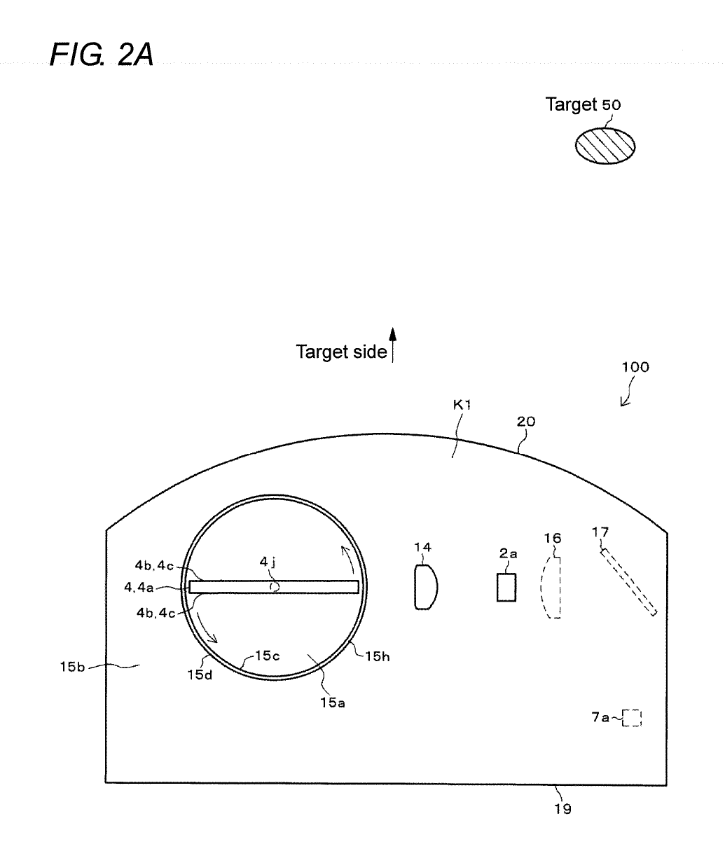

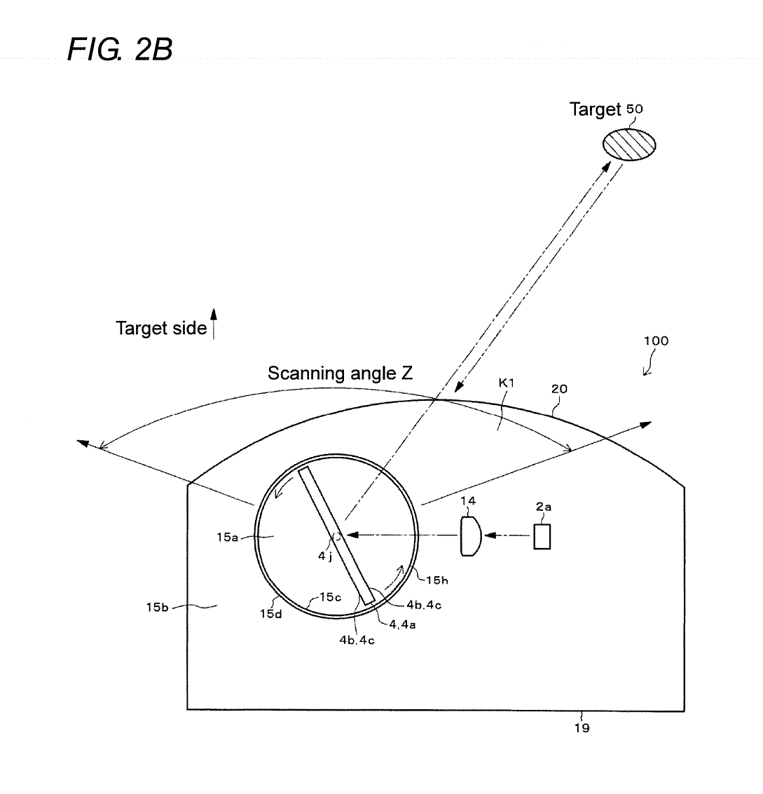

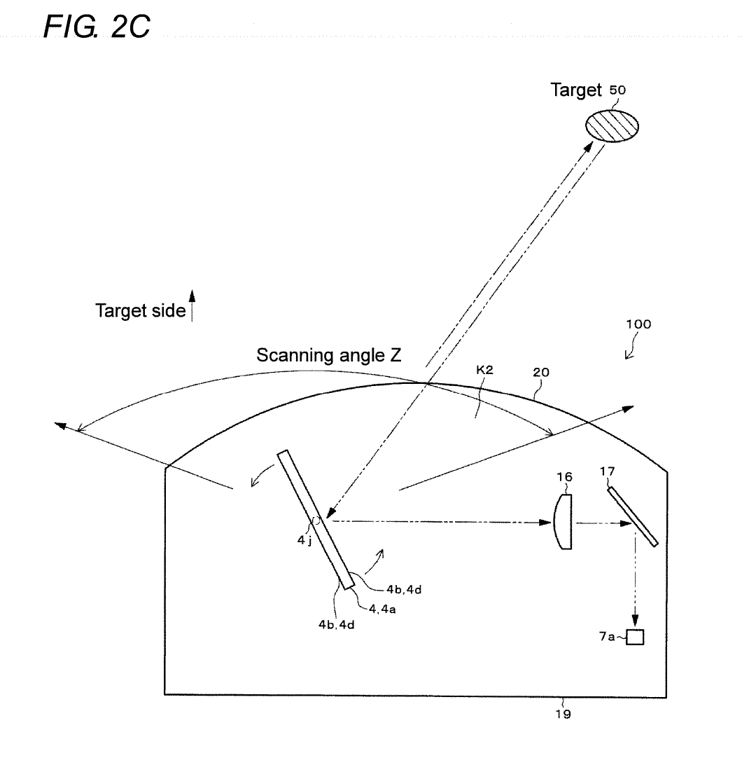

FIGS. 1A and 1B are views of an optical system of a target detecting device 100 as viewed from the rear (side opposite to a target 50 in FIGS. 2A to 2C). FIGS. 2A and 2B are views of the optical system of the target detecting device 100 as viewed from above (upper side in FIGS. 1A and 1B). FIG. 2C is a top view of the lower side with respect to light shielding portions 15a, 15b of FIG. 1B. Note that orientation of a mirror 4a of an optical scanner 4 in FIG. 1A differs from that in FIG. 1B. FIG. 2A illustrates a state corresponding to the orientation of the mirror 4a in FIG. 1A, and FIGS. 2B and 2C illustrate a state corresponding to the orientation of the mirror 4a in FIG. 1B.

The target detecting device 100 is configured of, for example, a laser radar mounted on a four-wheeled automobile. The optical system of the target detecting device 100 includes an LD (Laser Diode) 2a, a light projecting lens 14, an optical scanner 4, a light receiving lens 16, a reflecting mirror 17, and an APD (Avalanche Photo Diode) 7a.

Among them, the LD 2a, the light projecting lens 14, and the optical scanner 4 constitute a light projecting optical system. The optical scanner 4, the light receiving lens 16, the reflecting mirror 17, and the APD 7a constitute a light receiving optical system.

These optical systems are accommodated in a casing 19 of the target detecting device 100. The front surface (target 50 side) of the casing 19 is open. A transmission window 20 illustrated in FIG. 2A and the like is provided on the front surface of the casing 19. The transmission window 20 is made of a rectangular window frame and a light-transmissive plate material fitted in the window frame (not illustrated in detail).

The target detecting device 100 is installed at a front part, a rear part, a right side or a left side of a vehicle so that the transmission window 20 faces the area in front of, behind, to the right, or to the left of the vehicle. The target detecting device 100 detects presence or absence of the target 50 existing in front of, behind, to the right, or to the left of the vehicle, and the distance to the target 50. The target 50 is a vehicle other than the vehicle on which the target detecting device 100 is installed, a person, or an object other than those.

The LD 2a is a light emitting element that projects high-power laser light (optical pulse). In FIG. 1A to 2B, for the sake of convenience, only one LD 2a is illustrated; however, actually, a plurality of LDs 2a is arranged in the top-bottom direction (vertical direction) in FIG. 1A and the like. The LD 2a is disposed such that the light emitting surface thereof is directed toward the optical scanner 4.

The APD 7a is a light receiving element that receives light projected from the LD 2a and then reflected by the target 50. Light reception sensitivity of the APD 7a is higher than light reception sensitivity of a PD (Photo Diode). In FIGS. 1A to 2A and 2C, for the sake of convenience, only one APD 7a is illustrated; however, actually, a plurality of APD 7a is arranged in the top-bottom direction (or the right-left direction) in FIG. 1A and the like. The APD 7a is disposed such that the light receiving surface thereof is directed toward the reflecting mirror 17.

The optical scanner 4 is also referred to as a scanning mirror, a rotary scanner, or an optical deflector. The optical scanner 4 includes a mirror 4a, a motor 4f, and the like.

The mirror 4a is formed in a plate shape. Both plate surfaces (front surface and rear surface) of the mirror 4a are reflecting surfaces 4b. As illustrated in FIG. 1A and the like, the motor 4f is provided below the mirror 4a. A rotary shaft 4j of the motor 4f is parallel to the top-bottom direction. A connecting shaft (not illustrated) located at the center of the mirror 4a is fixed to the upper end of the rotary shaft 4j of the motor 4f. The mirror 4a rotates in conjunction with the rotary shaft 4j of the motor 4f.

In the casing 19, the LD 2a and the light projecting lens 14 are disposed around the upper part of the mirror 4a of the optical scanner 4. The light receiving lens 16, the reflecting mirror 17, and the APD 7a are disposed around the lower part of the mirror 4a. The plate-shaped light shielding portions 15a, 15b that block light are provided below the LD 2a and the light projecting lens 14 and above the light receiving lens 16, the reflecting mirror 17, and the APD 7a. The light shielding portions 15a, 15b are configured of a movable light shielding portion 15a provided on the mirror 4a and a fixed light shielding portion 15b fixed to the casing 19.

As illustrated in FIGS. 2A, 2B, the movable light shielding portion 15a is formed in a circular shape when viewed from above. The movable light shielding portion 15a is fixed to the center of the mirror 4a so as to protrude from the mirror 4a perpendicularly to the rotary shaft 4j (see FIGS. 1A and 1B). In conjunction with rotation of the mirror 4a about the rotary shaft 4j, the movable light shielding portion 15a also rotates about the rotary shaft 4j.

The movable light shielding portion 15a partitions each of the reflecting surfaces 4b on the front and rear surfaces of the mirror 4a into an upper half and a lower half. A first reflecting region 4c (upper half) located above the movable light shielding portion 15a of each reflecting surface 4b reflects projected light from the LD 2a. A second reflecting region 4d (lower half) located below the movable light shielding portion 15a of each reflecting surface 4b reflects reflected light from the target 50. In FIGS. 1A and 1B, only one reflecting surface 4b is illustrated; however, the other reflecting surface 4b is similar (see FIGS. 2A to 2C). As described above, the mirror 4a has the first reflecting region 4c and the second reflecting region 4d that are located on the identical reflecting surface 4b.

The fixed light shielding portion 15b is provided in the casing 19 so as to surround the movable light shielding portion 15a. As illustrated in FIG. 1A and the like, the fixed light shielding portion 15b is fixed to the casing 19 in a horizontal posture so as to divide the internal space of the casing 19 into an upper space and a lower space. A through hole 15h vertically penetrating the fixed light shielding portion 15b is formed. The movable light shielding portion 15a is fitted in the through hole 15h.

An outer peripheral portion 15c of the movable light shielding portion 15a faces an inner peripheral portion 15d of the through hole 15h of the fixed light shielding portion 15b. The movable light shielding portion 15a and the fixed light shielding portion 15b are close to each other to such an extent that the fixed light shielding portion 15b does not disturb rotation of the mirror 4a and the movable light shielding portion 15a.

A light projecting path and a light receiving path during detection of the target 50 are as indicated by alternate long and short dash line arrows and two-dots chain line arrows, respectively, in FIGS. 1B, 2B, and 2C. Specifically, as illustrated by the alternate long and short dash line arrows in FIGS. 1B and 2B, the light projecting lens 14 adjusts spreading of projected light projected from the LD 2a, and then the projected light hits the first reflecting region 4c of any one of the reflecting surfaces 4b of the mirror 4a of the optical scanner 4. At this time, the motor 4f rotates, the orientation (angle) of the mirror 4a changes, and the mirror 4a is positioned at a predetermined angle at which one of the reflecting surfaces 4b of the mirror 4a is directed toward the target 50 (for example, the state of the mirror 4a that FIGS. 1B and 2B illustrate). As a result, after the projected light from the LD 2a passes through the light projecting lens 14, the projected light is reflected by the first reflecting region 4c of the mirror 4a, and passes through the transmission window 20. Thus, a predetermined range outside the casing 19 is scanned with the projected light (See also FIG. 2C).

A scanning angle Z illustrated in FIGS. 2B and 2C is a predetermined range (top view) in which projected light from the LD 2a is reflected by the first reflecting region 4c of the mirror 4a of the optical scanner 4 and is projected from the target detecting device 100. That is, this scanning angle Z is a detection range in the horizontal direction of the target detecting device 100 for the target 50.

As described above, projected light that the target detecting device 100 projects onto the predetermined range is reflected by the target 50 in the predetermined range. The reflected light travels toward the target detecting device 100 as indicated by the two-dots chain line arrows in FIGS. 1B, 2B and 2C, passes through the transmission window 20, and hits the second reflecting region 4d of one of the front and rear reflecting surfaces 4b of the mirror 4a (See. FIG. 2C). At this time, the motor 4f rotates, the orientation of the mirror 4a changes, and the mirror 4a is positioned at a predetermined angle at which one of the front and rear reflecting surfaces 4b of the mirror 4a is directed toward the target 50 (for example, the state of the mirror 4a in FIGS. 2B and 2C). As a result, reflected light from the target 50 is reflected by the second reflecting region 4d of the mirror 4a and enters the light receiving lens 16. Then, the reflected light is concentrated by the light receiving lens 16, is reflected by the reflecting mirror 17, and is received by the APD 7a. That is, the optical scanner 4 scans reflected light from the target 50, and guides the reflected light to the APD 7a via the light receiving lens 16 and the reflecting mirror 17.

As illustrated in FIGS. 1A and 1B, the light shielding portions 15a, 15b partitions the casing 19 into a light projecting space (internal space above the light shielding portions 15a, 15b) K1 through which projected light from the LD 2a travels, and a light receiving space (internal space below the light shielding portions 15a, 15b) K2 through which reflected light from the target 50 travels. The light shielding portions 15a, 15b prevent projected light from the LD 2a from traveling from the light projecting space K1 to the light receiving space K2 and reflected light from the target 50 from traveling from the light receiving space K2 to the light projecting space K1.

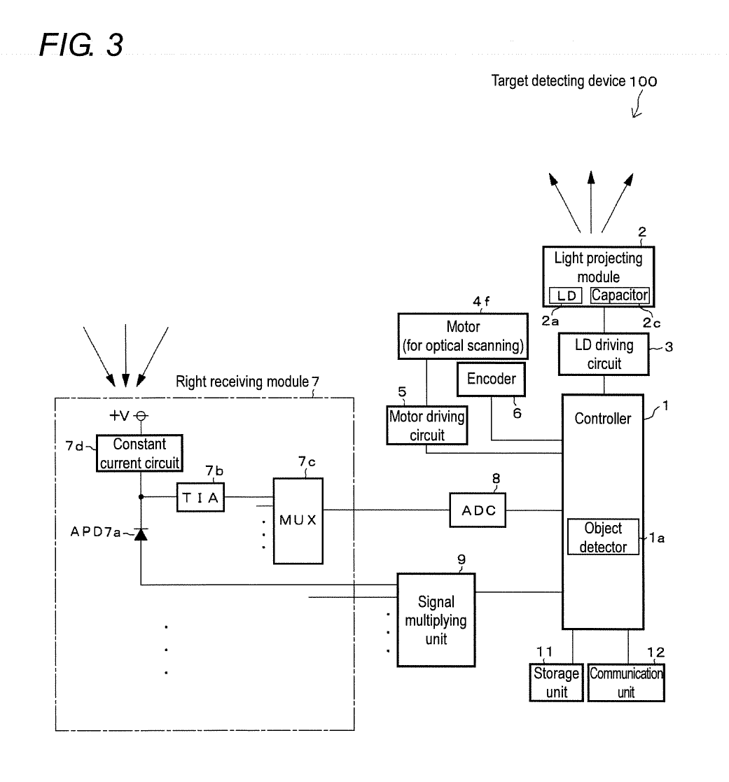

FIG. 3 is a diagram illustrating an electrical configuration of the target detecting device 100. The target detecting device 100 includes a controller 1, a light projecting module 2, an LD driving circuit 3, the motor 4f, a motor driving circuit 5, an encoder 6, a light receiving module 7, an ADC (Analog to Digital Converter) 8, a storage unit 11, and a communication unit 12. Each of the above units is also housed in the casing 19 (FIG. 1A, and the like).

The controller 1 is configured of a microcomputer or the like, and controls operation of each unit of the target detecting device 100. The controller 1 is provided with an object detector 1a.

The storage unit 11 is configured of a volatile or a nonvolatile memory. The storage unit 11 stores information for the controller 1 to control each unit of the target detecting device 100, information for detecting the target 50, and the like.

The communication unit 12 is configured of a communication circuit for communicating with another device mounted on the vehicle. The controller 1 causes the communication unit 12 to transmit and receive various information to and from another device.

The light projecting module 2 is provided with a plurality of LDs 2a described above, a capacitor 2c for causing each LD 2a to emit light, and the like. In FIG. 3, for the sake of convenience, one block of the LD 2a and one block of the capacitor 2c are illustrated.

The controller 1 causes the LD driving circuit 3 to control operation of the LD 2a of the light projecting module 2. Specifically, the controller 1 uses the LD driving circuit 3 to cause the LD 2a to emit light so as to project laser light. In addition, the controller 1 uses the LD driving circuit 3 to stop light emission of the LD 2a and to charge the capacitor 2c.

The motor 4f is a driving source for rotating the mirror 4a of the optical scanner 4. The controller 1 uses the motor driving circuit 5 to control driving of the motor 4f so as to rotate the mirror 4a. Then, the controller 1 rotates the mirror 4a to scan the predetermined range with laser light projected from the LD 2a and to guide reflected light reflected by the target 50 in the predetermined range to the APD 7a. In these cases, the controller 1 detects the rotation state (rotation angle, rotation speed, and the like) of the motor 4f and the mirror 4a according to output from the encoder 6.

The light receiving module 7 includes the APD 7a, a TIA (Trans Impedance Amplifier) 7b, an MUX (Multiplexer) 7c, and a constant current circuit 7d. A plurality of APDs 7a, TIAs 7b, and constant current circuits 7d are provided such that one APD 7a, one TIA 7b, and one constant current circuit 7d form a set. In FIG. 3, a first set of the APD 7a, the TIA 7b, and the constant current circuit 7d is representatively illustrated. Second and following sets of the APD 7a, the TIA 7b, and the constant current circuit 7d are similarly provided. The APD 7a and the TIA 7b in each set constitute a light receiving channel. That is, the light receiving module 7 is provided with a plurality of light receiving channels.

A cathode of the APD 7a is connected to a power supply +V via the constant current circuit 7d. An input terminal of the TIA 7b is connected between the cathode of the APD 7a and the constant current circuit 7d. An output terminal of the TIA 7b is connected to the MUX 7c. An anode of the APD 7a is connected to a signal multiplying unit 9.

The APD 7a outputs current by receiving light. The TIA 7b converts current having flowed through the APD 7a into a voltage signal and outputs the voltage signal to the MUX 7c. In order to suppress power consumption of the APD 7a, the constant current circuit 7d limits current flowing through the APD 7a.

The signal multiplying unit 9 is configured of a DC-DC converter and a PWM (pulse width modulation) circuit for generating a reference voltage to be input to the DC-DC converter. The controller 1 causes the DC-DC converter of the signal multiplying unit 9 to control a reverse voltage (reverse bias voltage) to be applied to each APD 7a so as to multiply current that the APD 7a outputs upon light reception.

The MUX 7c selects an output signal of each TIA 7b and outputs the output signal to the ADC 8. The ADC 8 converts an analog signal output from the MUX 7c into a digital signal at a high speed and outputs the digital signal to the controller 1. That is, a voltage signal corresponding to the light reception state of each APD 7a is output from the light receiving module 7 to the controller 1 via the ADC 8.

The object detector 1a of the controller 1 processes the output signal from the ADC 8 and extracts a feature point (maximum value or the like) of the light reception signal from the light receiving module 7 in a predetermined time. Then, the object detector 1a detects the presence or absence of the target 50 according to the feature point. Specifically, for example, the object detector 1a compares a light reception signal output from the light receiving module 7 via the ADC 8 with a predetermined threshold. If the light reception signal is equal to or greater than the threshold, the object detector 1a determines that the target 50 is present, and if the light reception signal is less than the threshold, the object detector 1a determines that the target 50 does not exist.

In addition, the object detector 1a detects the maximum value of the light reception signal that is equal to or greater than the threshold, and detects the reception time point of reflected light reflected by the target 50, according to the maximum value. Then, the object detector 1a calculates the distance to the target 50 according to the light reception time point of the reflected light and the projection time point of laser light from the LD 2a (so-called TOF (Time of Flight) method).

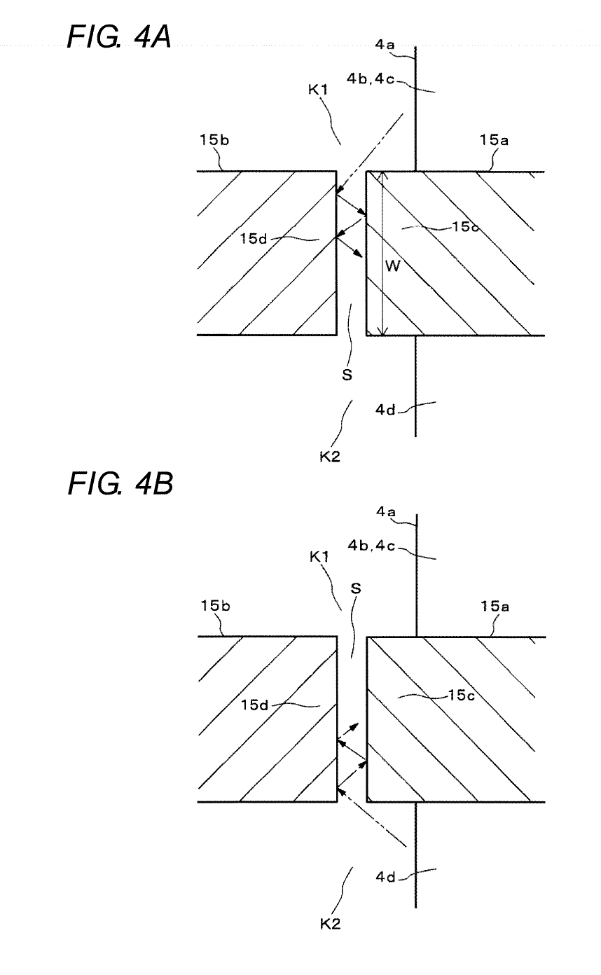

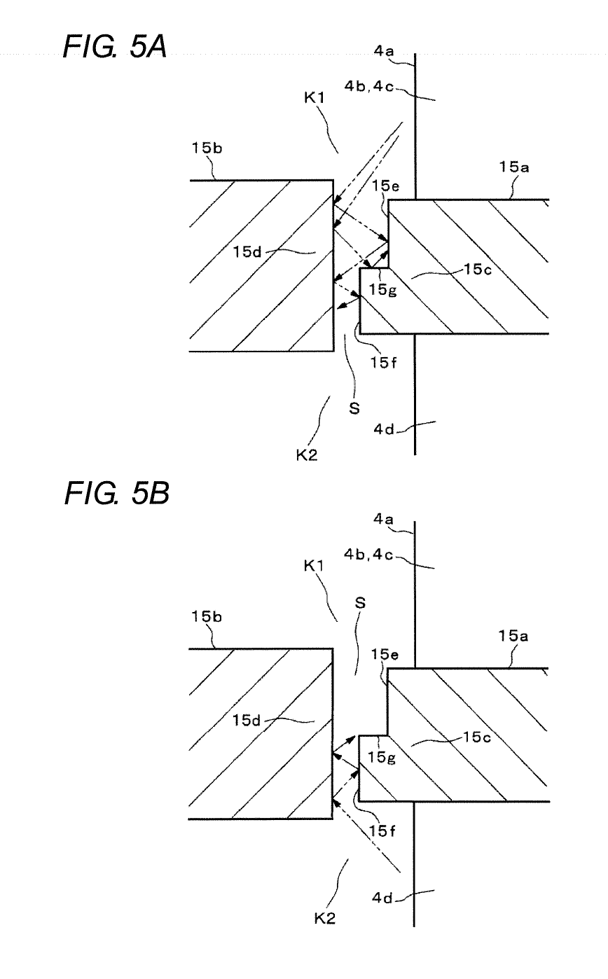

FIGS. 4A and 4B are enlarged sectional views of a main part of a first embodiment. More specifically, FIGS. 4A and 4B are enlarged sectional views of the outer peripheral portion 15c of the movable light shielding portion 15a and the inner peripheral portion 15d of the through hole 15h of the fixed light shielding portion 15b in a vertical plane including the rotary shaft 4j illustrated in FIG. 1A and the like. (Embodiments to be described later illustrated in FIG. 5A and the following figures are similar.)

In order to smoothly rotate the mirror 4a of the optical scanner 4, it is necessary to provide a gap S between the movable light shielding portion 15a and the fixed light shielding portion 15b. As illustrated in FIGS. 4A and 4B, the gap S between the outer peripheral portion 15c of the movable light shielding portion 15a and the inner peripheral portion 15d of the fixed light shielding portion 15b facing the outer peripheral portion 15c is set to be narrow to such an extent that the fixed light shielding portion 15b does not inhibit rotation of the mirror 4a and the movable light shielding portion 15a.

A width Win the vertical direction in which the outer peripheral portion 15c and the inner peripheral portion 15d face each other is expanded to such an extent that stray light is diffusely reflected at least a plurality of times by each end surface of the outer peripheral portion 15c and the inner peripheral portion 15d. In FIGS. 4A and 4B, the width W is equal to the thickness of each the light shielding portions 15a, 15b. Note that the thickness of the movable light shielding portion 15a and the thickness of the fixed light shielding portion 15b may differ from each other.

According to the above embodiment, in the light projecting space K1 through which projected light from the LD 2a travels and the light receiving space K2 through which reflected light from the target 50 travels in the casing 19 of the target detecting device 100, part of the light projecting space K1 and part of the light receiving space K2 near the mirror 4a of the optical scanner 4 are separated by the movable light shielding portion 15a provided on the mirror 4a. In addition, part of the light projecting space K1 and part of the light receiving space K2 surrounding the movable light shielding portion 15a are separated by the fixed light shielding portion 15b fixed to the casing 19. Therefore, for example, the movable light shielding portion 15a and the fixed light shielding portion 15b prevent part of projected light from the LD 2a from becoming stray light and entering the light receiving space K2 from the light projecting space K1, and prevent part of reflected light from the target 50 from becoming stray light and entering the light projecting space K1 from the light receiving space K2. Therefore, it is possible to effectively reduce the likelihood that the APD 7a will receive the stray light. In addition, as a result, it is possible to limit noise included in a light reception signal output from the APD 7a to a low level and to keep detection accuracy of the target 50 high according to the light reception signal.

In addition, in the above embodiment, the gap S between the movable light shielding portion 15a and the fixed light shielding portion 15b is set to be narrow to such an extent that the fixed light shielding portion 15b does not inhibit rotation of the mirror 4a and the movable light shielding portion 15a. Therefore, even if part of projected light from the LD 2a is reflected by the mirror 4a or another member or passes by the mirror 4a to become stray light, it is possible to reduce the likelihood that the stray light will pass through the gap S from the light projecting space K1 and will enter the light receiving space K2. In addition, even if part of reflected light from the target 50 is reflected by the mirror 4a or another member or passes by the mirror 4a to become stray light, it is possible to reduce the likelihood that the stray light will pass through the gap S from the light receiving space K2 and will enter the light projecting space K1. Further, as indicated by arrows in FIGS. 4A and 4B, even if stray light enters the gap S, the end surfaces of the light shielding portions 15a, 15b on both sides of the gap S can diffusely reflect the stray light so that the stray light can be attenuated. Therefore, the stray light hardly reaches the APD 7a, and it is possible to further reduce the likelihood that the APD 7a will receive the stray light.

Further, in the above embodiment, the optical scanner 4 including the mirror 4a is used. The mirror 4a has the first reflecting region 4c that reflects projected light and the second reflecting region 4d that reflects reflected light. The first reflecting region 4c and the second reflecting region 4d are located in an identical reflecting surface 4b. The movable light shielding portion 15a is provided so as to separate the first reflecting region 4c and the second reflecting region 4d. Therefore, the size of the target detecting device 100 can be further reduced compared with a case of using an optical scanner that reflects projected light and reflected light on different reflecting surfaces or a case of using an optical scanner that uses a mirror to scan only one of projected light and reflected light.

FIGS. 5A and 5B are enlarged sectional views of a main part of a second embodiment. In the second embodiment, a step 15g is provided on an outer peripheral portion 15c of a movable light shielding portion 15a. The step 15g is formed between an end surface 15e and an end surface 15f. The end surface 15f closer to a second reflecting region 4d of a mirror 4a is closer to an inner peripheral portion 15d of a fixed light shielding portion 15b than the end surface 15e closer to a first reflecting region 4c of the mirror 4a is. Therefore, the interval between an end surface of the inner peripheral portion 15d and the end surface 15f is narrower than the interval between the end surface of the inner peripheral portion 15d and the end surface 15e.

By providing the step 15g on the outer peripheral portion 15c of the movable light shielding portion 15a as described above, as indicated by arrows in FIGS. 5A and 5B, even if stray light from the light projecting space K1 and the light receiving space K2 enters the gap S between the movable light shielding portion 15a and the fixed light shielding portion 15b, the end surfaces 15e, 15f, the step 15g, and the end surface of the inner peripheral portion 15d of the fixed light shielding portion 15b can diffusely reflect the stray light so that the stray light can be attenuated. In addition, since the diffuse reflection state of stray light in the gap S becomes complicated, the attenuation degree of stray light can be improved. Further, the end surface 15f closer to the second reflecting region 4d is closer to the inner peripheral portion 15d of the fixed light shielding portion 15b than the end surface 15e closer to the first reflecting region 4c is. Therefore, even if stray light passes through between the first end surface 15e and the end surface of the inner periphery portion 15d while being diffusely reflected, the stray light is more diffusely reflected between the end surface 15f and the end surface of the inner peripheral portion 15d so as to be reliably attenuated. Therefore, the likelihood that stray light will enter the light receiving space K2 from the light projecting space K1 can be further reduced.

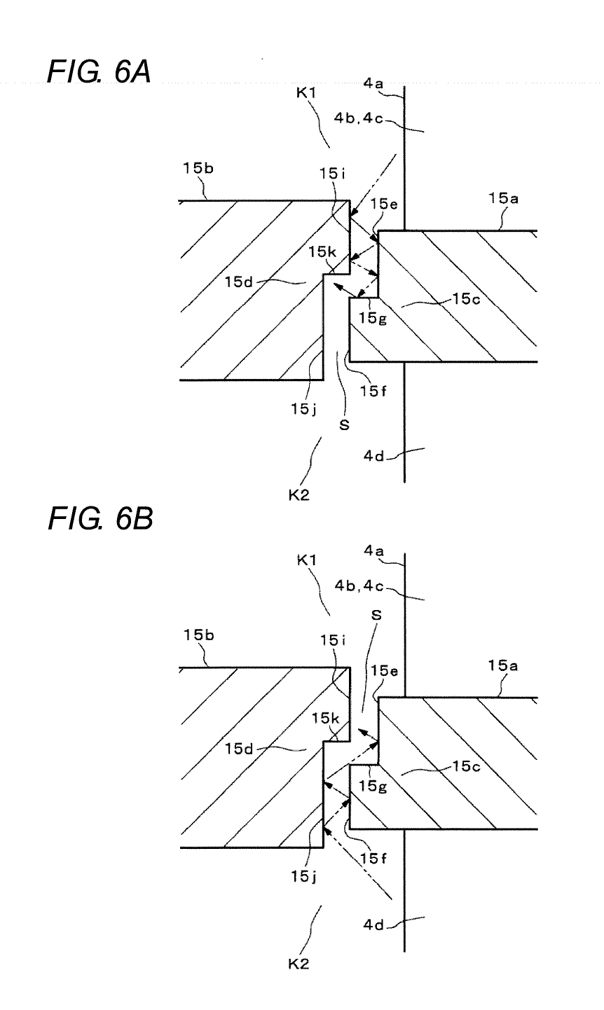

FIGS. 6A and 6B are enlarged sectional views of a main part of a third embodiment. A step 15g identical to that in the second embodiment (FIGS. 5A and 5B) is provided on an outer peripheral portion 15c of a movable light shielding portion 15a. In the third embodiment, a step 15k formed between end surfaces 15i and 15j is also provided on an inner peripheral portion 15d of a fixed light shielding portion 15b. The interval between an end surface 15e and the end surface 15i facing each other and the interval between an end surface 15f and the end surface 15j facing each other may be identical to or different from each other.

By providing the steps 15g, 15k on the outer peripheral portion 15c of the movable light shielding portion 15a and the inner peripheral portion 15d of the fixed light shielding portion 15b, respectively, as described above, a bent gap S is formed between the movable light shielding portion 15a and the fixed light shielding portion 15b. Therefore, as indicated by arrows in FIGS. 6A and 6B, stray light having entered the gap S between the movable light shielding portion 15a and the fixed light shielding portion 15b is diffusely reflected by the end surfaces 15e, 15f, 15i, 15j and the steps 15g, 15k so that the stray light can be reliably attenuated. In addition, since the stray light path in the bent gap S becomes complicated and the number of diffuse reflections increases, the attenuation degree of stray light can be improved.

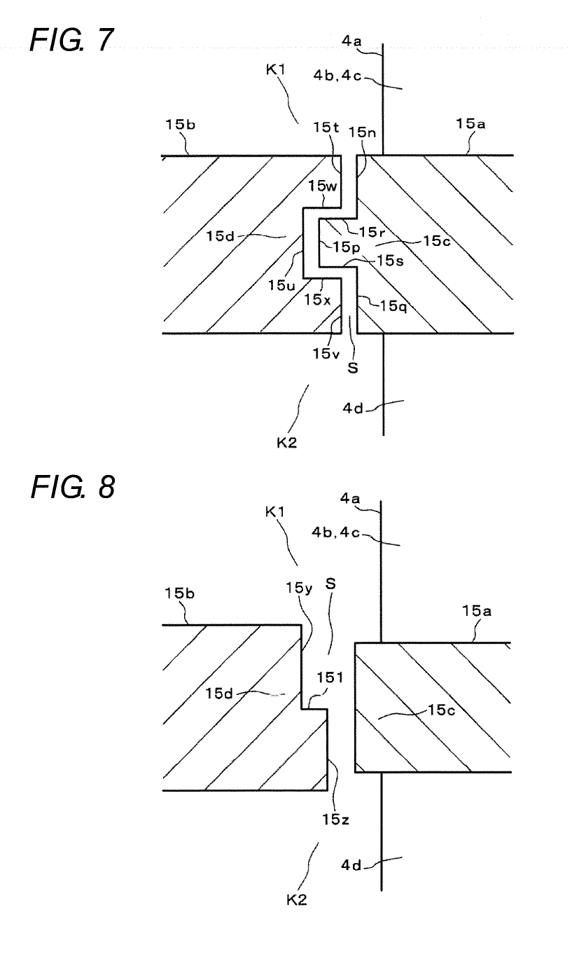

FIG. 7 is an enlarged sectional view of a main part of a fourth embodiment. An outer peripheral portion 15c of a movable light shielding portion 15a is formed in a projecting shape so as to protrude toward an inner peripheral portion 15d of a fixed light shielding portion 15b. The inner peripheral portion 15d of the fixed light shielding portion 15b is formed in a recessed shape such that the inner peripheral portion 15d recessed toward the side opposite to the outer peripheral portion 15c of the movable light shielding portion 15a correspondingly to the outer peripheral portion 15c. That is, the inner peripheral portion 15d of the fixed light shielding portion 15b and the outer peripheral portion 15c of the movable light shielding portion 15a are formed into a recessed shape and a projecting shape so as to be fitted with each other.

As a result, on the outer peripheral portion 15c of the movable light shielding portion 15a, a step 15r is formed between end surfaces 15n, 15p and a step 15s is formed between the end surface 15p and an end surface 15q. In addition, on the inner peripheral portion 15d of the fixed light shielding portion 15b, a step 15w is formed between end surfaces 15t, 15u and a step 15x is formed between the end surface 15u and an end surface 15v. Due to these plurality of steps, a gap S which is more sharply bent than that in FIGS. 6A and 6B is formed between the movable light shielding portion 15a and the fixed light shielding portion 15b. Therefore, the end surfaces 15n, 15p, 15q, 15t, 15u, 15v and the steps 15r, 15s, 15w, 15x can diffusely reflect stray light having entered the gap S between the outer peripheral portion 15c and the inner peripheral portion 15d from a light projecting space K1 and a light receiving space K2. Therefore, the stray light can be further attenuated.

In addition, as a fifth embodiment, as illustrated in FIG. 8, a step 151 may be provided only on an inner peripheral portion 15d of a fixed light shielding portion 15b. The step 151 is formed between an end surface 15y and an end surface 15z. The end surface 15z closer to a second reflecting region 4d of a mirror 4a is closer to an outer peripheral portion 15c of a movable light shielding portion 15a than the end surface 15y closer to a first reflecting region 4c of the mirror 4a is. Therefore, the interval between the end surface 15z and an end surface of the outer peripheral portion 15c is narrower than the interval between the end surface 15y and the end surface of the outer peripheral portion 15c. Also with such a structure, it is possible to reduce the likelihood that stray light will enter a light receiving space K2 from a light projecting space K1.

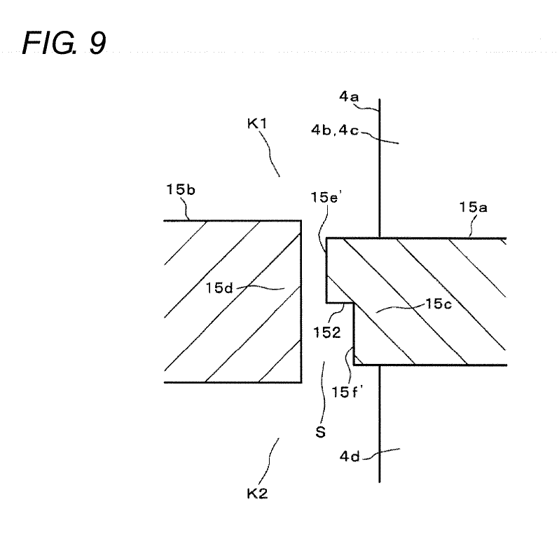

In addition, as a sixth embodiment, as illustrated in FIG. 9, out of end surfaces 15e′, 15f′ of an outer peripheral portion 15c of a movable light shielding portion 15a, the end surface 15e′ closer to a first reflecting region 4c of a mirror 4a may be closer to an inner peripheral portion 15d of a fixed light shielding portion 15b than the end surface 15f′ closer to a second reflecting region 4d of the mirror 4a. Also with such a structure, it is possible to reduce the likelihood that stray light will enter a light receiving space K2 from a light projecting space K1.

Although not illustrated, in still another embodiment, a plurality of steps formed between end surfaces may be formed on an outer peripheral portion 15c of a movable light shielding portion 15a and an inner peripheral portion 15d of a fixed light shielding portion 15b, and the number of end surfaces may be four or more. In addition, in contrast to FIG. 7, an outer peripheral portion 15c may be formed in a recessed shape, and an inner peripheral portion 15d may be formed in a projecting shape correspondingly to the outer peripheral portion 15c. Alternatively, only one of an outer peripheral portion 15c and an inner peripheral portion 15d may be formed in a projecting shape or a recessed shape. In addition, both an outer peripheral portion 15c and an inner peripheral portion 15d may be formed in a projecting shape or a recessed shape. In this case, the outer peripheral portion 15c and the inner peripheral portion 15d may not be formed into a recessed shape and a projecting shape so as to be fitted with each other but may be shifted in a thickness direction (top-bottom direction).

The present invention can adopt various embodiments other than the above-described embodiments. For example, the above embodiments describe examples in which the plate-shaped movable light shielding portion 15a and fixed light shielding portion 15b are provided. However, the present invention is not limited to them, and for example, a sheet-shaped, a film-shaped, or a block-shaped movable light shielding portion and fixed light shielding portion may be provided. In addition, each of the movable light shielding portion and the fixed light shielding portion may be configured of one piece or a plurality of pieces. In addition, unlike the above embodiments in which the fixed light shielding portion is provided so as to surround the entire periphery of the movable light shielding portion, a fixed light shielding portion may be provided so as to surround part of a movable light shielding portion. In addition, a step may be provided so as to be annularly continuous or a step may be discontinuously provided on an outer peripheral portion of a movable light shielding portion or an inner peripheral portion of a fixed light shielding portion. In addition, a recess and a projection may be provided so as to be annularly continuous or may be discontinuously provided on an outer peripheral portion of a movable light shielding portion or an inner peripheral portion of a fixed light shielding portion.

In addition, the above embodiments illustrate examples where the LD 2a is used as the light emitting element and the APD 7a is used as the light receiving element. However, the present invention is not limited to them. A suitable number of light emitting elements other than an LD may be provided in a light projecting module 2. In addition, for example, a PIN-type PD, an SPAD (Single Photon Avalanche Diode) which is a Geiger-mode APD, an MPPC (Multi Pixel Photon Counter) formed by connecting a plurality of SPADs in parallel, or the like may be provided in a light receiving module 7 as a light receiving element. Further, the number and arrangement of light emitting elements and light receiving elements may be appropriately selected.

In addition, the above embodiments describe examples in which the optical scanner 4 is used. The optical scanner 4 uses the motor 4f to rotate the mirror 4a so as to change the orientation of the mirror 4a. Thus, the optical scanner 4 performs scanning with projected light and reflected light. However, the present invention is not limited to the above examples. In addition to the above, for example, an optical scanner may be used which swings a mirror by using an actuator to change the orientation of the mirror so as to perform scanning with projected light and reflected light.

In addition, the above embodiments describe examples in which the light projecting optical system and the light projecting space K1 are provided above the light shielding portions 15a, 15b and the light receiving optical system and the light receiving space K2 are provided below the light shielding portions 15a, 15b. However, the present invention is not limited to them, and a light projecting optical system and a light projecting space may be provided below light shielding portions 15a, 15b, and a light receiving optical system and a light receiving space may be provided above the light shielding portions 15a, 15b.

Further, the above embodiments describe examples in which the present invention is applied to the target detecting device 100 including the on-vehicle laser radar. However, the present invention can be also applied to a target detecting device for another intended use.

1. A target detecting device comprising:
a light emitting element configured to project light;
a light receiving element configured to receive light and to output a light reception signal;
an optical scanner including a mirror and configured to change orientation of the mirror to cause the mirror to reflect projected light projected from the light emitting element to scan a predetermined range and to cause the mirror to reflect reflected light from a target in the predetermined range of the projected light to guide the reflected light to the light receiving element;
a detector configured to detect the target according to the light reception signal that the right receiving element outputs according to a light reception state of the reflected light; and
a casing configured to store the light emitting element, the light receiving element, the optical scanner, and the detector,
the device further comprising a light shielding portion configured to partition the casing into a light projecting space through which the projected light travels and a light receiving space through which the reflected light travels and configured to block light,
the mirror having a first reflecting region which reflects the projected light and a second reflecting region which reflects the reflected light, the first reflecting region and the second reflecting region being located in an identical reflecting surface, and
the light shielding portion including:
a movable light shielding portion provided on the mirror so as to separate the first reflecting region and the second reflecting region and configured to be movable in conjunction with the mirror; and
a fixed light shielding portion fixed to the casing so as to surround the movable light shielding portion.

2. The target detecting device according to claim 1, wherein a gap between the movable light shielding portion and the fixed light shielding portion is set to be narrow to such an extent that the fixed light shielding portion does not inhibit movement of the mirror and the movable light shielding portion.

3. The target detecting device according to claim 1, wherein a step is provided on at least one of an outer peripheral portion of the movable light shielding portion and an inner peripheral portion of the fixed light shielding portion facing the outer peripheral portion.

4. The target detecting device according to claim 3,
wherein the step is provided on the outer peripheral portion of the movable light shielding portion,
wherein the step is formed between an end surface of the outer peripheral portion closer to the first reflecting region and an end surface of the outer peripheral portion closer to the second reflecting surface, and
wherein one of the end surfaces is closer to the inner peripheral portion of the fixed light shielding portion than the other end surface is.

5. The target detecting device according to claim 3,
wherein the step is provided on the inner peripheral portion of the fixed light shielding portion,
wherein the step is formed between an end surface of the inner peripheral portion closer to the first reflecting region and an end surface of the inner peripheral portion closer to the second reflecting region, and
wherein one of the end surfaces is closer to the outer peripheral portion of the movable light shielding portion than the other end surface is.

6. The target detecting device according to claim 3,
wherein the step is provided on the outer peripheral portion of the movable light shielding portion and the step is also provided on the inner peripheral portion of the fixed light shielding portion, and
wherein the step on the outer peripheral portion and the step on the inner peripheral portion form a bent gap between the movable light shielding portion and the fixed light shielding portion.

7. The target detecting device according to claim 3, wherein one of the outer peripheral portion of the movable light shielding portion and the inner peripheral portion of the fixed light shielding portion is formed in a projecting shape so as to protrude toward the other of the outer peripheral portion and the inner peripheral portion and has a plurality of steps, and the other is formed in a recessed shape so as to be recessed toward a side opposite to the one and has a plurality of steps.
